(19) United States
(12) Patent Application Publication
(10) Pub. No.: US 2018/0269743 A1
(43) Pub. Date: Sep. 20, 2018

(54) LIQUID-COOLED ELECTRIC MACHINE

(71) Applicant: SIEMENS AKTIENGESELLSCHAFT, Munchen (DE)

(72) Inventors: KLAUS BÜTTNER, Hollstadt (DE); KLAUS KIRCHNER, Ostheim (DE); ARDIAN TROPOJA, Münnerstadt (DE); NICO WOLF, Trusetal (DE)

(73) Assignee: SIEMENS AKTIENGESELLSCHAFT, Munchen (DE)

(21) Appl. No.: 15/515,476

(22) PCT Filed: Sep. 18, 2015
(86) PCT No.: PCT/EP2015/071463

§ 371 Date: Mar. 29, 2017

(30) Foreign Application Priority Data
Sep. 30, 2014 (DE) 10 2014 219 739.2

(51) Int. Cl. H02K 5/124; H02K 9/19; H02K 11/20

(52) U.S. Cl. CPC H02K 5/124; H02K 17/16; H02K 11/20; H02K 9/19

(57) ABSTRACT

An electric machine includes a stator, a rotatably mounted rotor interacting with the stator and including a shaft which has an axial borehole. A flow guiding element extends into the axial borehole such as to enable a coolant to flow out of the flow guiding element and into the axial borehole or into the flow guiding element and out of the axial borehole. A slide ring seal seals the shaft with the axial borehole with respect to an element that is rotationally stationary relative to the shaft. When the electric machine is in operation, a value for moisture in a cavity of the electric machine can be determined in a cavity of the electric machine.

The invention relates to an electric machine, in particular an asynchronous machine, having a cooled rotor.

An electric machine is used to convert energy from electrical energy into mechanical energy and vice versa. On conversion of energy from mechanical energy into electrical energy, the electric machine is used as a generator. On conversion of energy from electrical energy into mechanical energy, the electric machine is used as a motor. In both cases it is desirable to achieve a high degree of efficiency with a high power density. The high degree of efficiency is required in order to be able to provide energy in a cost-effective and resource-saving manner. A high power density is required, since it is desirable to cost-effectively manufacture electric machines with a lower material usage, or, on account of weight-sensitive applications of the electric machine, to develop the same with a lower mass. Examples of weight-sensitive applications are applications in which the carrying structure for the electric machine is expensive, or the electric machine is transported in the application from one location to another location. This relates for instance to vehicle manufacturing, in other words in particular an electric machine in an electric vehicle or also a hybrid vehicle. In order to achieve a high degree of efficiency with a high power density, the principles and designs of the electric machines and their cooling are improved.

DE 10 2012 203 697 A1 discloses an electric machine for instance, which has a shaft with an axial borehole. A flow guiding element thus extends into the axial borehole such that a coolant, in particular a cooling liquid, can flow out of the flow guiding element into the axial borehole. A seal which is arranged on the shaft such that the cooling liquid can press the seal against the shaft is provided for sealing purposes. The seal is pressed against the shaft by means of air, which is disposed in a cavity between a retaining element, i.e. a gap seal and the further seal.

One object of the invention is to specify an electric machine with an effective sealing of a cooling medium.

One solution of the object becomes apparent with an electric machine having the features as claimed in claim 1 and with a method for operating the electric machine as claimed in claim 9. Further embodiments of the solution become apparent in accordance with the dependent claim 2 to 8 or 10.

An electric machine, which is in particular an asynchronous machine, has a stator and a rotor. The rotor is rotatably mounted and connected in a torsion-proof manner to a shaft. The shaft is thus part of the rotor. The shaft has an axial borehole. In order to cool the electric machine, a cooling medium is provided which is in particular a cooling liquid. The cooling medium cools the rotor and thus the electric machine in particular by way of the shaft of the rotor. The cooling medium can be inserted into the axial borehole of the shaft. This is achieved using a flow guiding element. The flow guiding element guides the flow of the cooling medium in the axial borehole. The flow guiding element extends e.g. into the axial borehole such that the coolant, in particular a cooling liquid, can flow out of the flow guiding element into the axial borehole or into the flow guiding element out of the axial borehole. A slide ring seal is available for sealing the opening of the axial borehole. The sealing relates for instance to a leak-tightness with regard to a space in the electric machine, which has the air gap between the stator and the rotor or in which a winding head of the stator is disposed. The slide ring seal is a robust seal with a long service life, so that a replacement of the seal need not be expected for the lifetime of the electric machine. The slide ring seal seals the rotationally movable shaft with the axial borehole with respect to an element which is rotationally stationary thereto. This element is for instance a connecting flange for the supply or discharge of the cooling medium.

In one embodiment of the electric machine, the slide ring seal has a slide ring and a counter ring, wherein the slide ring is connected to the shaft and the counter ring is connected to the element which is stationary with respect to the rotor. The stationary element is a bearing shield or a carrier for instance for fastening the flow guiding element or a connecting element, in other words the connecting flange for routing cooling medium into or out of the shaft of the electric machine. A surface area which seals a space with cooling medium from a space without cooling medium is formed between the slide ring and the counter ring. The slide ring can be moved with respect to the counter ring with the shaft. The slide ring and counter ring can therefore be moved with respect to one another.

In one embodiment of the electric machine, a first sealing ring seals the slide ring with respect to the shaft. The first sealing ring and the slide ring can move with the shaft. The first sealing ring is thus stationary with respect to the slide ring.

In one embodiment of the electric machine, a second sealing ring seals the counter ring with respect to the stationary element. The second sealing ring is thus stationary with respect to the stationary element.

In one embodiment of the electric machine the cooling liquid has water and/or glycol or consists thereof. The ratio of water to glycol is 50% to 50% for instance.

In one embodiment of the electric machine, the slide ring of the slide ring seal is arranged so as to act axially on the counter ring. The shaft is fixed axially and also radially using bearings. The position of the counter ring in relation to the slide ring, which is fastened to the shaft, can thus be easily defined, by, for this purpose, the axial position of the counter ring being adjustable with respect to the carrier for instance. Therefore the axial pressure between the slide ring and the counter ring can be changed by a variable axial positioning of the counter ring in relation to the carrier of the counter ring. If no pressure is exerted between the slide ring and the counter ring, the axial gap between the slide ring and counter ring can thus be changed. The positioning of the counter ring with respect to its carrier occurs by way of distance holders such as screws or shaped inserts with different thicknesses for instance.

In one embodiment of the electric machine, the counter ring of the slide ring seal has a ceramic, in particular a sintered ceramic. A ceramic is low-wear and thus contributes to a long service life of the electric machine.

In one embodiment of the electric machine, this has a moisture sensor. The moisture sensor is provided in a cavity, which means that the moisture sensor is attached at least in or on the electric machine such that moisture in a cavity of the electric machine can be measured using this. It is thus possible to determine whether there is threat of corrosion. If excessive moisture is determined, a heater in the electric machine can be switched on for instance, which may be required particularly during downtimes of the electric machine.

In one method of operating the electric machine, in one of the described embodiments, a value for moisture in a cavity of the electric machine is determined. The determined value can then be evaluated.

In one embodiment of the method, the value is transferred to an evaluation facility, wherein the evaluation facility determines whether the slide ring seal is to be replaced. If the slide ring seal is leaking, the coolant may enter a dry part of the electric machine and cause damage. This can be prevented by means of the evaluation facility. This is achieved for instance by the electric machine no longer being operable with excessive moisture values (when a threshold value is exceeded) and no longer being able to be placed under voltage.

The electric machine is a drive for a vehicle for instance. The vehicle is e.g. an electric car or a hybrid car, the propulsion of which can be achieved using the electric machine. Use of the slide ring seal in conjunction with the cooling of the rotor by way of the shaft with the borehole permits a compact design. This compact design is suited to small installation spaces in a vehicle.

Various positive effects can be achieved by using the slide ring seal, such as e.g.:
an easy to maintain sealing system,
an easily replaceable sealing system, since one part can be detached axially;
a good sealing with a high peripheral speed;
a good suitability to sealing a water/glycol mixture as a cooling medium;
a good compensation possibility of deviations in shape and/or length and/or position between the motor shaft and the sealing system and
a good adjustability of the sealing system to a changed system pressure, which was caused due to a change in design for instance.

The slide ring seal has advantages with respect to a sealing of the rotor cooling system with radial shaft sealing ring. On account of high peripheral speeds and deviations in shape and position and a lack of lubrication, increased wear may occur on the sealing lip in the case of the radial shaft sealing ring. The sealing lip may however be reinforced with special filling materials in order to achieve a suitability for a high peripheral speed. The filling materials can however result in increased wear on the shaft surface, which renders necessary additional expensive processing steps such as curing, grinding and polishing. In order to prevent damage when assembling the shaft sealing ring, assembly assistance or a special geometry is required on the shaft.

Problems of this type can be reduced and/or avoided by using the slide ring seal. The sealing system of a slide ring seal is wear-free with conventional lubrication and is well suited to sealing water/glycol cooling media at high rotational speeds (>20,000/min). The clever design of the sealing geometry achieves a sealing system which acts independently of the system pressure. The sealing system acts axially on a counter ring comprising a sintered technical special ceramic. Sealing systems, such as e.g. a shaft sealing ring, act directly radially on the motor shaft and thus result in wear on this, which in turn in some instances renders necessary a replacement. With a slide ring seal, there is no wear on the motor shaft. A slide ring seal can be easily assembled and disassembled.

The invention is described by way of example below using figures. The same reference characters are used for similar elements in the figures, in which:

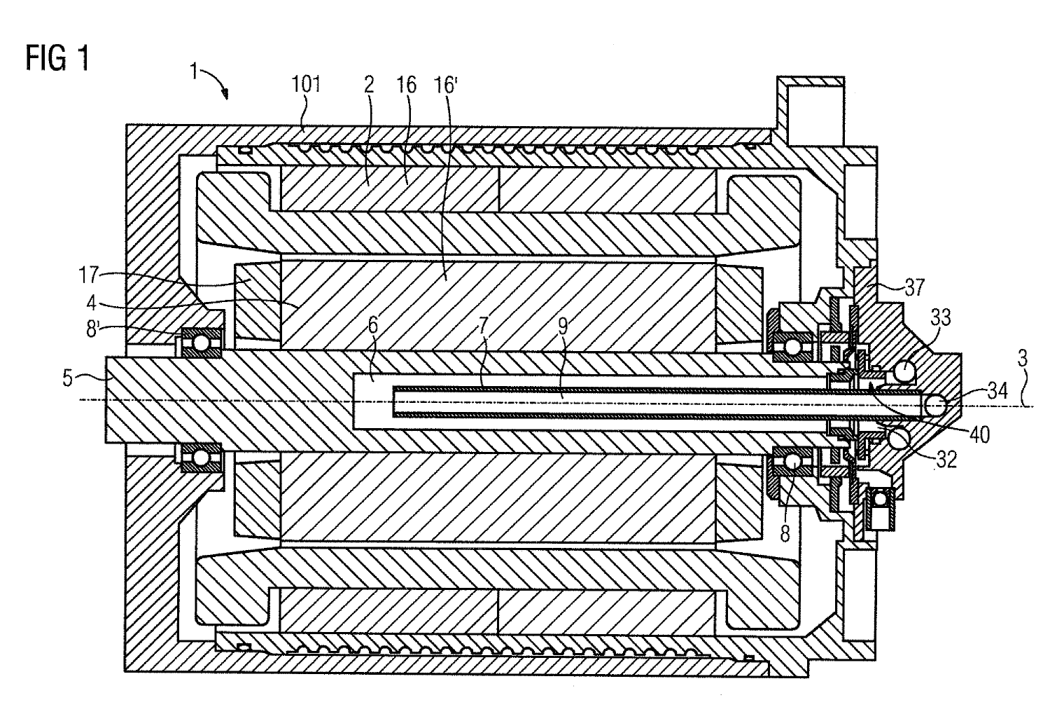

FIG. 1 shows an electric machine with a slide ring seal;

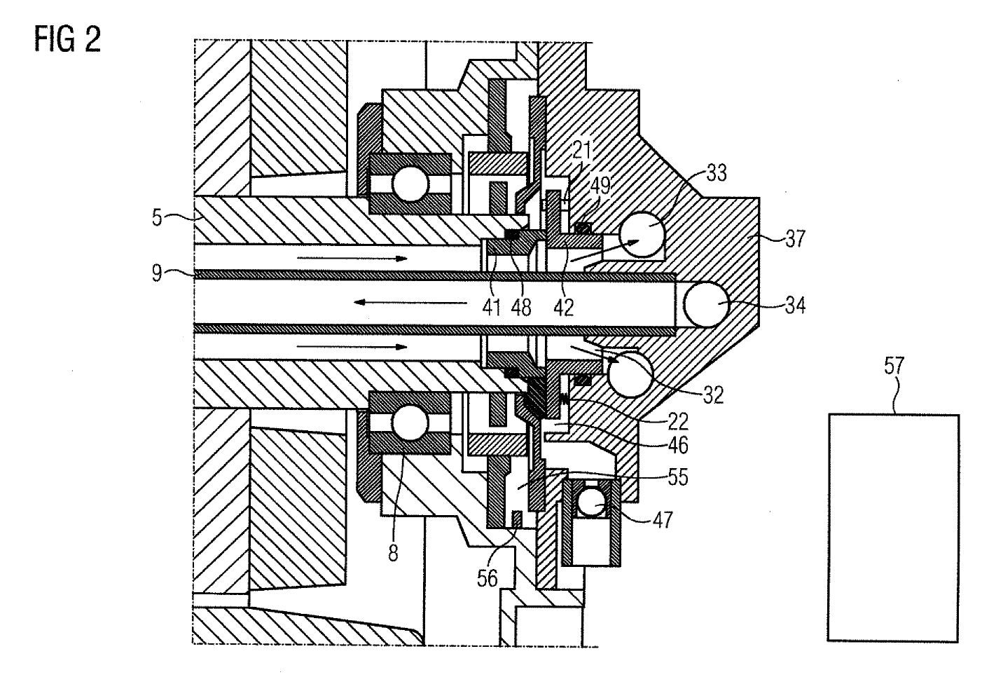

FIG. 2 a cut-out of the first electric machine;

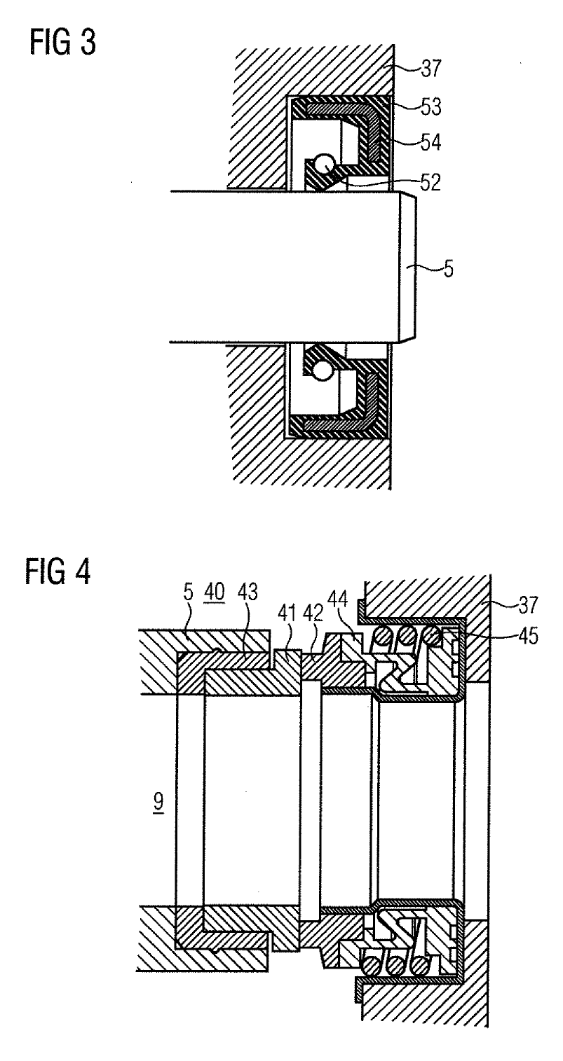

FIG. 3 a radial shaft sealing ring;

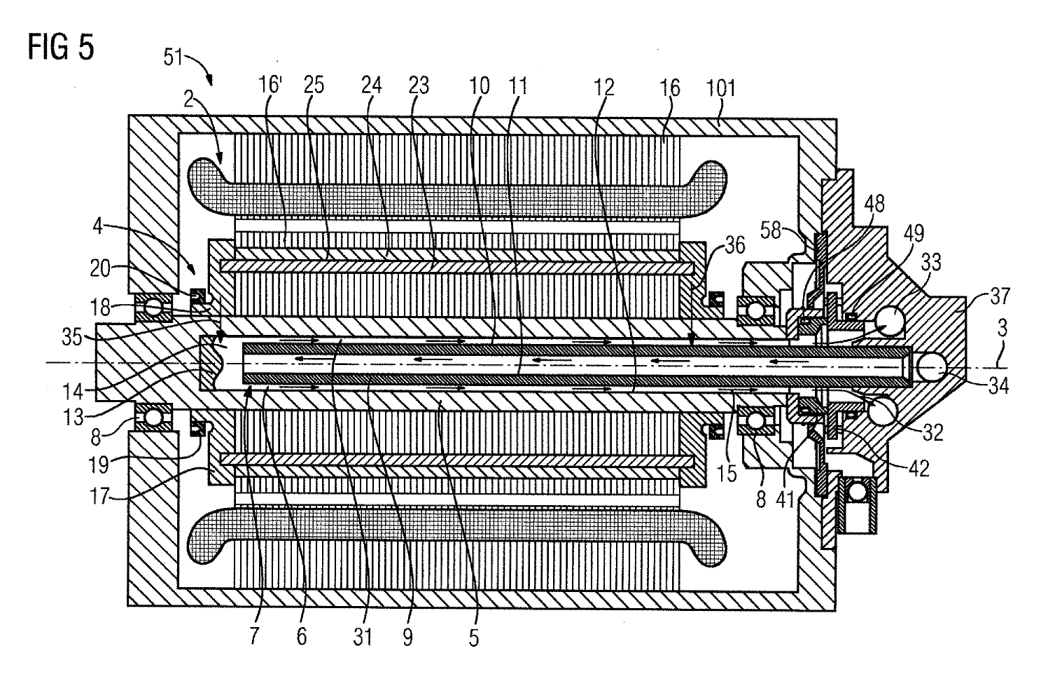

FIG. 4 a slide ring seal and

FIG. 5 the electric machine with a representation of the flow of the cooling medium.

The representation according to FIG. 1 shows an electric machine 1 with a housing 101. A stator 2 and a rotor 4, wherein the rotor 4 can be rotated about an axis 3 by way of bearings 8 and 8′, is disposed in the housing 101. The stator 2 has a laminated core 16 and the rotor has a laminated core 16′. The electric machine is an asynchronous machine with a short-circuit ring 17. A shaft 5 of the rotor 4 has an axial borehole 6, into which a flow guiding element 7 for guiding a coolant protrudes, wherein the flow guiding element 7 has an inlet pipe 9. The inlet pipe 9 is fed with coolant through a coolant inflow 34, in a carrier 37 supporting the pipe 9, which represents a stationary element. The coolant leaves the electric machine 1 again by way of a coolant outflow 33, which connects to a hollow cylindrical space 32. The sealing of the opening of the shaft 6 with respect to further parts of the rotor 4 and the stator 2 is achieved by means of the slide ring seal 40 which is shown in detail in FIG. 4. A flow of cooling medium in the shaft 5 is shown in FIG. 5.

Aside from the elements in FIG. 1, the representation according to FIG. 2 shows the slide ring seal 40 (see FIG. 4) with a slide ring 41 and a counter ring 42. The slide ring 41 is connected to the shaft 5, wherein a first sealing ring 48 is present between the shaft 5 and the slide ring 41. The slide ring 41 has carbon bound in a plastic for instance, in order to achieve a good sliding effect. The counter ring 42 is connected to the carrier 37, wherein a second sealing ring 49 is present between the carrier 37 and the counter ring 42. The sealing rings 48 and 49 are O-rings for instance. The counter ring 42 has SIC for instance. The counter ring 42 has in particular a torque support 21 and single springs 22, so that the counter ring 42 abuts the slide ring 41. Aside from a leakage chamber 46, the electric machine also has a cavity 55, wherein a sensor 56 measures the moisture in the cavity 55. The measured sensor value is evaluated in an evaluation facility 57. The sensor can also be positioned in the region of winding heads of the stator, which is not shown in FIG. 2, however. Coolant can additionally be discharged from the electric machine by way of a spherical valve 47.

The representation according to FIG. 3 shows a radial shaft sealing ring 53 according to the prior art as an alternative to the slide ring seal. The radial shaft sealing ring 53 has an angle reinforcement 54 and a spring 52, which presses the seal onto the shaft 5.

The representation according to FIG. 4 shows a slide ring seal (40), in which the slide ring 41 is connected by way of a rubber-elastic receiver 43 to the shaft. The slide ring 41 adjoins the counter ring 42 in a planar manner, wherein the counter ring 42 is connected by way of a rubber-elastic bellows 44 to a carrier 37. This carrier is stationary and cannot be moved rotationally by way of bearings. The bellows 44 is in particular an elastomer bellows. A spring 45, in particular a spiral spring, presses the counter ring 42 against the slide ring 41. The spring 45 is in particular a single spring. The spring 45 rests here at least indirectly against the carrier 37. The balanced slide ring seal shown can be installed as a preassembled unit.

FIG. 5 shows the electric machine 1 with the flow of the cooling medium. The rotor 4 is rotatably mounted about the axis of rotation 3, by the shaft 5 being mounted in the housing 101 by way of the bearings 8, 8′. In this exemplary embodiment the bearing 8 and 8′ is a ball bearing. Other bearings such as spherical bearings, needle bearings etc. can also be used, but are not shown. For cooling purposes a cooling liquid is used as a coolant 15, said cooling liquid consisting of water and glysantine G30® in the ratio of 50:50, or having these substances.

The shaft 5 of the rotor 4 has an axial borehole 6. A flow guiding element 7 extends from an open end of the shaft 5 into the axial borehole 6 such that the cooling liquid 15 can flow out of the flow guiding element 7 into the axial borehole 6. The flow guiding element 7 has an inlet pipe 9, which is fastened in or on a carrier 37 of the flow guiding element 7. The carrier 37 is fastened to the housing 101 of the electric machine 1.

To cool the electric machine 51, the cooling liquid 15 flows through the coolant inflow 34 into the inlet pipe 9. In the inlet pipe 9 the coolant 15 flows in the direction of a closed end of the axial borehole 6, where it leaves the inlet pipe 9 and is deflected by a transmission element 13. The transmission element 13 to this end has a recess 14, which is embodied to be rotationally symmetrical with respect to the axis of rotation 3, so that the cooling liquid only has minimal turbulences caused by deflecting the cooling liquid. The transmission element 13 is made of aluminum, so that it can transmit a significant quantity of waste heat, which it has received at the boundary 12 of the axial borehole 6 or at the closed end of the axial borehole 6, onto the cooling liquid 15. The shaft 5 was typically manufactured from a steel. On account of the larger thermal expansion coefficient of the transmission element 13 with regard to the conventional steel of the shaft 5, the transmission element is pressed against the boundary 12 of the axial borehole 6 so that an improved heat transfer between the boundary 12 of the axial borehole 6 and the transmission element 13 is present with an increasing temperature. Since the coolant liquid 15 was deflected by the transmission element 13, the cooling liquid 15 flows into the hollow cylindrical channel 31, which is formed by the boundary 12 of the axial borehole 6 and the outer surface 10 of the inlet pipe 9. At an open end of the shaft 5, the cooling liquid 15 then flows out of the hollow cylindrical channel 31 into the hollow cylindrical space 32. From there the cooling liquid 15 leaves the hollow cylindrical space 32 through a coolant outflow 33, which extends with a part of its cross-section through a cut-out of a radial boundary of the hollow cylindrical space 32 into the hollow cylindrical space 32.

The stator 2 has a laminated core 16 and the rotor 4 has a laminated core 16′. The rotor 4 also has copper rods 23, which are arranged in grooves 25 of the laminated core 16′. The copper rods 23 are short-circuited by short-circuit rings 17 cast from aluminum. In FIG. 5, a residual cross-section in the radial direction adjacent to the copper rods 23 is shown in a different hatching to the short-circuit rings 17. The residual cross-sections of the grooves 25 can be grouted independently of a casting of the short-circuit rings 17 or are grouted with aluminum 24 when the short-circuit rings 17 are cast.

The cast short-circuit rings 17 have a fastening area 18. This is connected directly to the shaft 5. This means that a surface of the short-circuit ring 17 in the vicinity of the fastening area 18 touches the surface of the shaft 5. To safeguard this contact between the short-circuit ring 17 and the shaft 5 over a large temperature range, a shrink ring 19 is arranged on the short-circuit ring 17 such that the fastening area 18 is disposed between the shrink ring 19 and the shaft 5. The shrink ring 19 is made of steel which expands less significantly with an increasing temperature than the aluminum of the short-circuit ring 17. The shrink ring 19 is used to attach balancing boreholes 20 when balancing the rotor. The number and depth of the balancing boreholes 20 and their arrangement on the shrink ring is dependent on the individual imbalance of the rotor 4.

If the components of the rotor 4, in particular the short-circuit rods 23, now heat up during operation of the electric machine 1, the waste heat is transported by way of the good thermal conductivity of the copper rods 23 into the short-circuit rings 17 and from the short-circuit rings 17 by way of their fastening area 18 into the shaft 5.

This is reproduced for one of the short-circuit rings 17 in FIG. 5 by arrow 35, which indicates a direction of the heat transmission into the transmission element 13. From the transmission element 13, the cooling liquid 15 absorbs the waste heat and can transport it to a coolant outflow 33. With the other of the short-circuit rings 17, the heat is transmitted from the shaft 5 directly onto the cooling liquid 15, as arrow 36 indicates.

The inlet pipe 9 is a pressure die casting made of aluminum. A more uniform cooling of the shaft 5 along the axis of rotation 3 is achieved by the good thermal conductivity of the aluminum. The waste heat which the cooling liquid 15 absorbs in the hollow cylindrical channel 31 can namely be transmitted by means of the good thermal conductivity of the inlet pipe 9 to a large extent onto the cooling liquid 15 within the inlet pipe 9. Therefore the relatively cold cooling liquid 15 within the inlet pipe 9 in the vicinity of the open end of the axial borehole 6 supports the cooling liquid 15 in the hollow cylindrical channel 31, by it already absorbing a certain amount of the waste heat herefrom through the aluminum of the inlet pipe 9.

What is claimed is:

1.-10. (canceled)

11. An electric machine, comprising:
a stator;
a rotatably mounted rotor interacting with the stator and including a shaft, said shaft having an axial borehole;
a flow guiding element extending into the axial borehole such as to enable a coolant to flow out of the flow guiding element and into the axial borehole or into the flow guiding element and out of the axial borehole; and
a slide ring seal configured to seal the shaft with the axial borehole with respect to an element being rotationally stationary relative to the shaft.

12. The electric machine of claim 11, wherein the coolant is a cooling liquid.

13. The electric machine of claim 11, wherein the slide ring seal includes a slide ring which is connected to the shaft, and a counter ring which is connected to the element that is stationary with respect to the rotor.

14. The electric machine of claim 13, further comprising a sealing ring configured to seal the slide ring with respect to the shaft.

15. The electric machine of claim 13, further comprising a sealing ring configured to seal the counter ring with respect to the element.

16. The electric machine of claim 11, wherein the coolant contains water and/or glycol.

17. The electric machine of claim 13, wherein the slide ring of the slide ring seal is arranged so as to act axially with respect to the counter ring.

18. The electric machine of claim 13, wherein the counter ring of the slide ring seal has a sintered ceramic.

19. The electric machine of claim 11, further comprising a moisture sensor arranged in a cavity of the electric machine.

20. A method for operating an electric machine, comprising:
arranging a moisture sensor in a cavity of the electric machine; and
determining a value for moisture in the cavity.

21. The method of claim 20, further comprising transferring the value to an evaluation facility; and determining by the evaluation facility whether replacement of the slide ring seal is needed.
